(19) United States
(12) Patent Application Publication
(10) Pub. No.: US 2004/0096057 A1
(43) Pub. Date: May 20, 2004

(54) Modular multiplication of multi-precision numbers

(76) Inventor: Stephen F. Moore, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/301,172

(22) Filed: Nov. 20, 2002

(51) Int. Cl. H04K 1/00

(52) U.S. Cl. 380/28

(57) ABSTRACT

A technique for modular multiplication of multi-precision numbers involves providing a table of pre-computed residues and reducing a large modular product to smaller modular equivalent using the table.

### CROSS REFERENCE TO RELATED APPLICATIONS

This application is related to co-pending U.S. patent application Ser. No. 10/______, (attorney docket no. 42P14851) filed on an even date herewith and entitled MODULAR REDUCTION OF MULTI-PRECISION NUMBERS, which is herein incorporated by reference in its entirety.

### FIELD OF THE INVENTION

The invention relates to computer implemented modular arithmetic, and more particularly to cryptography systems utilizing modular multiplication.

### BACKGROUND AND RELATED ART

The modular product operation multiplies two numbers, then computes the remainder of a division by a third number, commonly called the modulus. The modular product may be expressed in equation form as follows:

X×V MOD N (Eq. 1)

where X and V are the first and second multiplicands and N is the modulus. Because the operation produces a number less than the modulus (which is usually a smaller number than the result of the multiplication), the second part of the operation is called modular reduction. The remainder is also referred to as the residue (with respect to the modulus). The computation of the modular product occurs in many cryptographic algorithms that are components of secure communication protocols.

With reference to FIGS. 1-3, a first electronic system 1A is configured to exchange information with a second electronic system 1B in a variety of different example arrangements. For example, the system 1A may be a computer system including an optional display 2. Example computer systems having displays include, without limitation, a personal computer (PC), a notebook or laptop computer, a personal digital assistant (PDA), and a cellular telephone, pager, or text messaging device. System 1B may also be any of the foregoing types of devices. Alternatively, as illustrated, the system 1B may be a server, a network device, or other computing device which may or may not include a display. The system 1A may be configured for direct communication to the system 1B over a direct electrical connection 3 such as a wire, a coaxial cable, or other network cable (e.g. FIG. 1). The system 1A may also or alternatively be indirectly connected the system 1B with respective network connections 4A and 4B connected to a shared network 5. For example, the network 5 may include, without limitation, a local area network (LAN), a wide area network (WAN), a wireless network, or a distributed network, such as the internet (e.g. FIG. 2). System 1A and 1B may also or alternatively communicate wirelessly using respective transceivers 6A and 6B (e.g. FIG. 3), which may utilize radio frequency (RF) signals, microwave signals (e.g. 1 GHz or higher), or optical signals (e.g. infrared). In addition or alternatively, information may be exchanged between the systems 1A and 1B using removable storage devices 7A and 7B. Examples of removable media include, without limitation, magnetic storage such as floppy disks, hard disk drives, and memory cards, and optical storage such as compact discs (CDs) and digital versatile discs (DVDs). Systems 1A and 1B may be any of numerous different types of devices and numerous other means of communication between the systems 1A and 1B may be utilized, but whatever means is used to exchange information what is often desired is a secure protocol to facilitate the exchange.

One example of a secure communication protocol is the public key architecture (PKA). In this architecture, a user maintains a private key and a public key. The public key is made available to anyone who wishes to communicate with this user. Those wishing to send this user a message encrypt that message with the public key. The user then decrypts that message with the private key. A specific example is the RSA algorithm. A user B, has a private key consisting of a number D and a public key consisting of the numbers E and N. The user B keeps the private key D secret, but publishes the public information in a directory available to other users. Another user A who wishes to send user B a secure message M looks up user B's public information in the directory. The user A encrypts a message C by computing M^{E} MOD N and sends the encrypted message to the user B. The user B decrypts the original message M by computing C^{D} mod N. If an unintended user receives or intercepts the message C, they cannot easily decrypt it because the original message M is secret and the private key D is secret.

In order to increase the difficulty of guessing the private key D (also called the private exponent), very large numbers are used for the keys. For example, a 256 bit key is considered relatively weak, while a 2048 bit key is considered very strong. It is anticipated that the size of the keys will continue to grow as processing power increases. Because the values M, E, and N are each very large numbers (e.g. often either 512 or 1024 bits), it is clearly not feasible to perform the exponentiation by simple repeated multiplication. Nor is it feasible to compute the exponentiation and then do the modular reduction afterwards. Instead, various methods are utilized to compute the exponentiation by repeated multiplication and squaring, and performing the modular reduction between each multiplication or squaring operation.

There are various techniques to do the multiplication and squaring. A simple algorithm which provides reasonable efficiency is called binary exponentiation. Binary exponentiation involves representing the exponent as a binary number and either (1) squaring the cumulative result or (2) squaring the result and multiplying by the original value if the bit position of the exponent is a logical one. For example, consider the exponent E=11 and let the value of M=3. The binary representation of 11 is E=[1011] (E[3]=1; E[2]=0; E[1]=1; E[0]=1). The sequence of calculations of the result C are M; M²; (M²)²×M=M⁵; (M⁵)²×M=M¹¹. Substituting the value of 3 for M provides the following sequence of results:

| Bit value of E | Operation Performed | Value of C |
|---|---|---|
| E[3] = 1 | Square and multiply | C = M = 3 |
| E[2] = 0 | Square only | C = 3² = 9 |
| E[1] = 1 | Square and multiply | C = 9² = 81 × 3 = 243 |
| E[0] = 1 | Square and multiply | C = 243² = 59049 × 3 = 177147 |

The RSA algorithm is a public-key algorithm which uses modular exponentiation, and which includes performing the modular reduction. With reference to FIG. 4, an RSA encryption operation is illustrated using the binary exponentiation method. Initially the values of M, E, and N are input at block 11. An integer K is determined to be the number of bits necessary to represent the exponent E in binary form (e.g. If E=117 then K=7; 2⁷=128>117) at block 13. Next, at block 15, if the most significant bit E[K−1] in the binary representation of the exponent E is 1 then the initial value of the result C is set equal to M, otherwise C is initialized to 1. At block 17, for each bit position J (in descending order from J=K−2 down to 0) the following calculations are performed. First, at block 19, C is squared (C×C) and then the modular reduction by N is performed. Then, at block 21, if the bit of the exponent E[J] is a logical one, the intermediate result C is multiplied by M (C×M) and a further modular reduction by N is performed at block 23. Note that block 19 involves calculating a modular product of (C×C) MOD N and block 23 involves calculating a modular product (C×M) MOD N.

Using the same example (with the reduction), consider the exponent E=11, the value of M=3, and the modulus N=5. The number of bits K=4(2⁴=16>11). So the sequence of values of the result C are:

| | Operation | |
|---|---|---|
| Bit value | Performed | Value of C |
| E[3] = 1 | C initialized | C = M = 3 |
| E[2] = 0 | Square and | C = 3² MOD 5 = |
| | reduce (C² MOD N) | 9 MOD 5 = 4 |
| E[1] = 1 | Square and | C = 4² MOD 5 = |
| | reduce (C² MOD N) | 16 MOD 5 = 1 |
| | Multiply and | C = 1 × |
| | reduce (C × M MOD N) | 3 MOD 5 = 3 |
| E[0] = 1 | Square and | C = 3² MOD 5 = |
| | reduce (C² MOD N) | 9 MOD 5 = 4 |
| | Multiply and | C = 4 × |
| | reduce (C × M MOD N) | 3 MOD 5 = 2 |

To check the result: 3¹¹=177147 MOD 5=2, since 177147/5=35429 remainder 2.

The RSA algorithm aids the secure exchange of information over an unsecure channel. In contrast to the simple example described above, the numbers involved typically are very large (e.g. several hundred or thousands of bits), and many iterations of the operation are required for a single RSA calculation. Accordingly, there is a need for efficient implementations of the algorithm.

### BRIEF DESCRIPTION OF THE DRAWINGS

Various features of the invention will be apparent from the following description of preferred embodiments as illustrated in the accompanying drawings, in which like reference numerals generally refer to the same parts throughout the drawings. The drawings are not necessarily to scale, the emphasis instead being placed upon illustrating the principles of the invention.

FIG. 1 is a schematic representation of two electronic systems configured to exchange information.

FIG. 2 is another schematic representation of two electronic systems configured to exchange information.

FIG. 3 is another schematic representation of two electronic systems configured to exchange information.

FIG. 4 is a flow diagram of the RSA algorithm.

FIG. 5 is a flow diagram of building a table of residues for the modular product of a repeated value and powers of a base with respect to a modulus in accordance with some examples of the invention.

FIG. 6 is another flow diagram of building a table of residues for the modular product of a repeated value and powers of a base with respect to a modulus in accordance with some examples of the invention.

FIG. 7 is a flow diagram of performing modular multiplication of multi-precision numbers in accordance with some examples of the invention.

FIG. 8 is another flow diagram of performing modular multiplication of multi-precision numbers in accordance with some examples of the invention.

FIG. 9 is a flow diagram of building a table of residues for the modular reduction of powers of a base with respect to a modulus in accordance with some examples of the invention.

FIG. 10 is a flow diagram of performing modular reduction of multi-precision numbers in accordance with some examples of the invention.

FIG. 11 is another flow diagram of performing modular multiplication of multi-precision numbers in accordance with some examples of the invention.

FIG. 12 is another flow diagram of performing modular multiplication of multi-precision numbers in accordance with some examples of the invention.

FIG. 13 is a first table of residues in accordance with some examples of the invention.

FIG. 14 is a second table of residues in accordance with some examples of the invention.

FIG. 15 is a chart illustrating operations of a modular product and modular reduction in accordance with some examples of the invention.

FIG. 16 is a block diagram of an electronic system according to some examples of the invention.

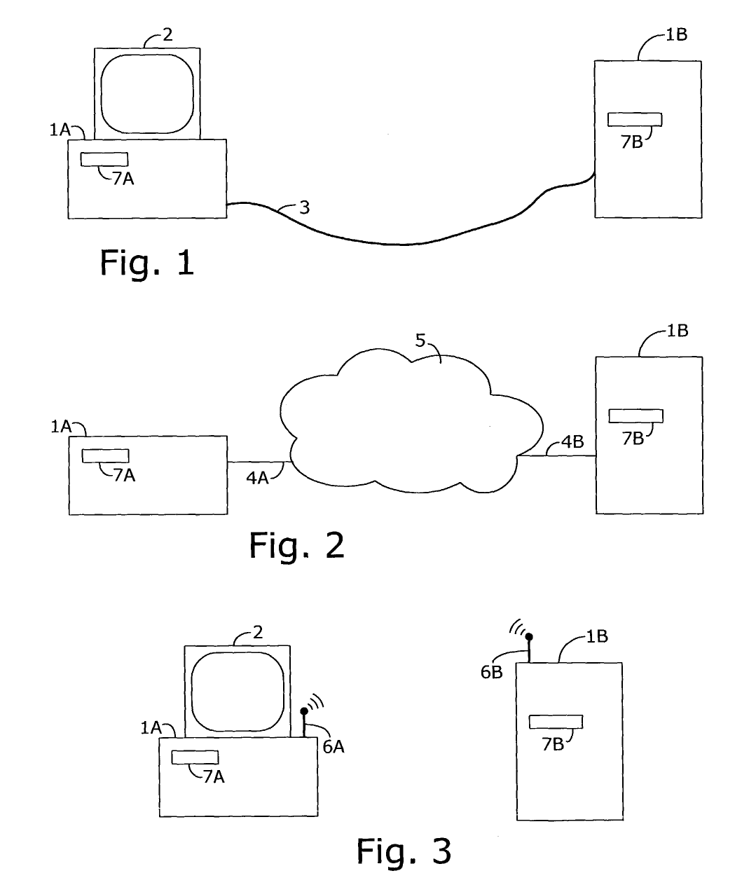

### DESCRIPTION

In the following description, for purposes of explanation and not limitation, specific details are set forth such as particular structures, architectures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well known devices, circuits, and methods are omitted so as not to obscure the description of the present invention with unnecessary detail.

Because the present invention may be implemented in software running on a computer, the numbers operated on will generally be implemented as binary quantities. However, because people have a more intuitive grasp of decimal arithmetic, the description below includes decimal arithmetic examples. Those skilled in the art will appreciate that, given the benefit of the present description, the examples and other embodiments of the invention can be readily mapped to binary arithmetic on a computer.

As used herein, the term “digit” refers to a nominal unit of operation. For example, if implemented on a computer, a digit may refer to a single word on the computer. Thus on an 8-bit processor, a single digit may have a value between zero and 2⁸−1 (e.g. 0 . . . 255); on a 16-bit processor a single digit may have a value between zero and 2¹⁶−1 (e.g. 0 . . . 65,535); on a 32-bit processor, a single digit may have a value between zero and 2³²−1, and so on. In the decimal arithmetic examples given below, a single digit has a value between zero and 10¹−1 (e.g. 0 . . . 9).

As noted above, various cryptography techniques utilize the modular product X×V MOD N. In many examples, certain of the values are utilized repeatedly (e.g. M and N in the RSA algorithm). Some examples of the present invention involve a table of pre-computed residues which is useful in improving the performance of calculating the modular product. In the following examples:

B corresponds to the base of operations;

S corresponds to the number of digits needed to represent N;

W corresponds to the word size used in the operations;

For example, B=2 for binary arithmetic and B=10 for decimal arithmetic. For a particular value V, a table of modular product residues with respect to N is provided for powers of the base multiplied by the value V:

V-Residue [J]=B^{W×J}×V MOD N; For J in 0 . . . S−1

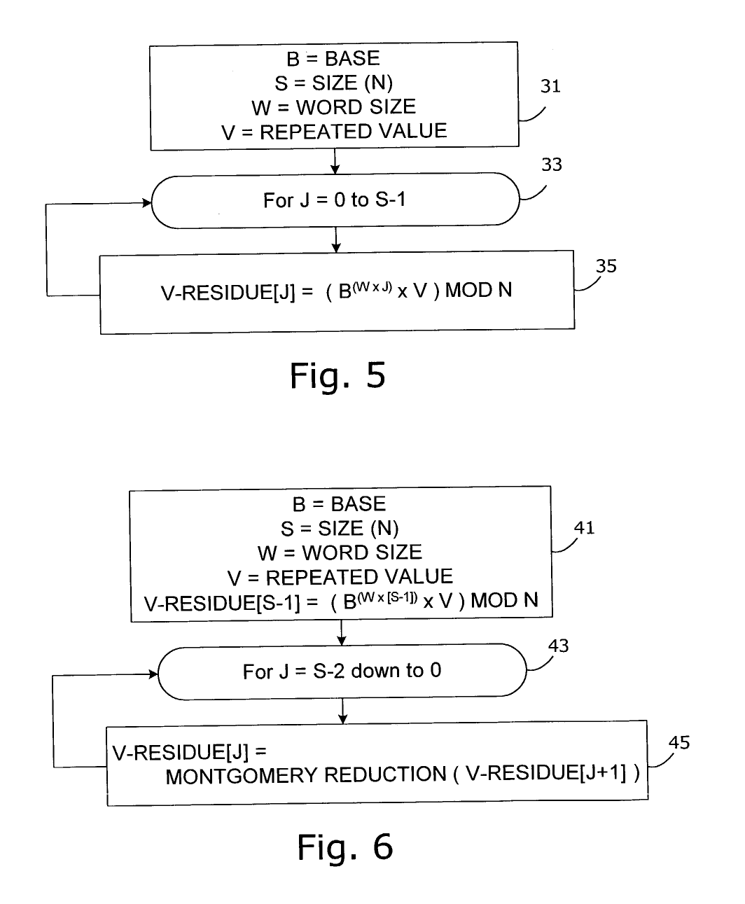

With reference to FIG. 5, a flow diagram shows one example of how to build a table V-Residue for a given base B, residue size S, word size W, and a repeated value V (31). An index variable J loops through values from zero to S−1 (33). Each indexed table entry V-Residue[J] is calculated by multiplying a corresponding power of the base B^{(W×J)} by the value V and performing a modular reduction with respect to N.

Example table entries are as follows:

| Table Index (J) | For B = 10 and W = 1 | For B = 2 and W = 32 |
|---|---|---|
| 0 | (10⁰ × V) MOD N | (2⁰ × V) MOD N |
| 1 | (10¹ × V) MOD N | (2³² × V) MOD N |
| 2 | (10² × V) MOD N | (2⁶⁴ × V) MOD N |
| . | . | . |
| . | . | . |
| . | . | . |
| S − 1 | (10^{S-1} × V) MOD N | (2^{32×(S-1)} × V) MOD N |

For V=5152 and N=9221, and S=4 (the number of digits in N), an example table is as follows:

| J | V-Residue[J] |
|---|---|
| 0 | (1 × 5152) MOD 9221 = 5152 |
| 1 | (10 × 5152) MOD 9221 = 5415 |
| 2 | (100 × 5152) MOD 9221 = 8045 |
| 3 | (1000 × 5152) MOD 9221 = 6682 |

An alternative technique for building a table of residues is to calculate the residue for the highest base power of interest and then perform a single digit Montgomery reduction for each of the smaller base powers in succession. Montgomery's techniques in connection with modular arithmetic are well known to those skilled in the art and are therefore not discussed in detail herein. Briefly, a Montgomery reduction, in the sense used here, considers the least significant digit of the number to be reduced. That digit is used to calculate a value which then can be multiplied by the modulus and added to the number to be reduced. The result is a number whose least significant digit is zero. This can be divided by the base to provide the next value in this table. Since there is a zero in the least significant digit, division by the base is a simple shift down.

With reference to FIG. 6, a flow diagram shows another example of how to build a table V-Residue for a given base B, residue size S, word size W, and repeated value V. The table entry for V-Residue[S−1] is calculated by multiplying the corresponding power of the base B^{(W×[S-1])} by the value V and performing a modular reduction with respect to N (41). An index variable J loops through values from S−2 down to 0 (43). Each indexed table entry V-Residue[J] is calculated by performing a Montgomery reduction on the previously calculated entry in the table (V-Residue[J+1]).

Because each table entry corresponds to a residue for the modular product of the value V multiplied by a base power, a modular equivalent to the modular product X×V MOD N can be determined by multiplying each digit of the number X by the table entry corresponding to the base power of the digit and adding all the results. An advantage of the present invention, for example for the RSA computation which must be performed repeatedly, is that the multiplication and reduction are combined into a single operation using the pre-computed table of residues.

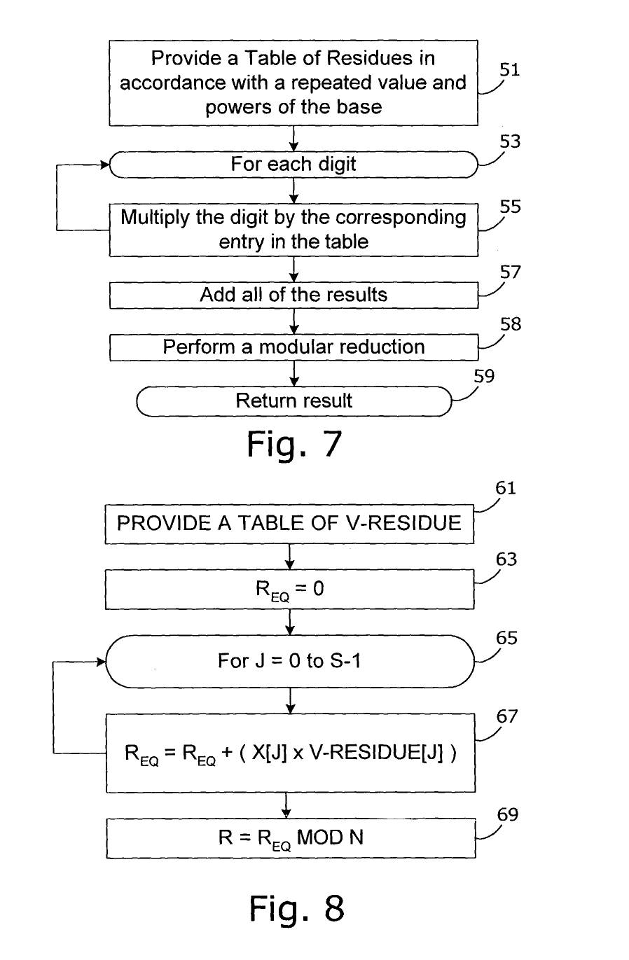

With reference to FIG. 7, a flow diagram shows how some examples of the invention involve building or providing a table of pre-computed modular product residues in accordance with powers of the base (51). For each digit (53), the digit is multiplied by a corresponding entry in the table (55). Each of the resulting products is added together (57) to provide an intermediate result (R_{EQ}) which is a modular equivalent to the desired modular product (R_{EQ} MOD N=X×V MOD N). Advantageously, the intermediate result R_{EQ} is a smaller number than the original product (X×V) and a simpler modular reduction may be performed (58) to provide the final result R (59).

The intermediate value R_{EQ} corresponds to the sum of the products of each digit in X multiplied by its corresponding entry in the residue table. For example, with reference to FIG. 8, a table of residues V-Residue is provided (61), for example, by building the table as described above. A variable R_{EQ} is initialized to zero (63). A index variable J loops from zero to S−1 (65). Each digit X[J] in X (X[0], X[1], etc.) is multiplied by a corresponding entry V-Residue[J] in the residue table and the results are added to the variable R_{EQ} (67). The sum of all of the multiplications corresponds to the intermediate value R_{EQ} which is the modular equivalent of the desired modular product. The final result R is calculated by performing the modular reduction of R_{EQ} with respect to N.

For X=8897, V=5152 and N=9221, an example reduction is as follows:

| Digit | Operation Performed | REQ |
|---|---|---|
| | R_{EQ} initialized to zero | R_{EQ} = 0 |
| X[0] = 7 | X[0] × V-Residue[0] => | R_{EQ} = 0 + 36064 = 36064 |
| | 7 × 5152 = 36064 | |
| X[1] = 9 | X[1] × V-Residue[1] => | R_{EQ} = 36064 + 48735 = 84799 |
| | 9 × 5415 = 48735 | |
| X[2] = 8 | X[2] × V-Residue[2] => | R_{EQ} = 84799 + 64360 = 149159 |
| | 8 × 8045 = 64360 | |
| X[3] = 8 | X[3] × V-Residue[3] => | R_{EQ} = 149159 + 53456 = 202615 |
| | 8 × 6682 = 53456 | |

To check the result: (8897×5152) MOD 9221=45837344 MOD 9221=8974; 202615 MOD 9221=8974=45837344 MOD 9221.

As noted above, some examples of the invention may provide particular advantages when one or more of the values in the modular product is re-used. For example, certain implementations of the RSA algorithm involve repeated use of M and N. In some practical situations, the value N corresponds to the public part of a security certificate for an entity and may not change frequently (e.g. not for months or years). Techniques other than the RSA algorithm may also make repeated use of a certain value or values for computing the modular product. By pre-computing residues related to these repeated values, some examples of the invention reduce the total amount of computation.

A further advantage of some examples of the invention is the reduction of serial dependencies in the calculation. Each of the multiplications of the digits of X with the corresponding table entry may be calculated independently and in any order. Likewise, each of the additions of the resulting products may be calculated independently and in any order. Accordingly, the technique is well suited for parallel processing and the further performance improvement that such parallel processing may provide. This increased parallelism can be exploited by the superscalar nature of modern processors, or by multi-threading techniques.

As noted above, the intermediate result R_{EQ} is a much smaller number that may be reduced by simpler modular reduction techniques. Such simpler techniques include conventional modular reduction calculations. A new technique for modular reduction is described in the above-mentioned related application entitled MODULAR REDUCTION OF MULTI-PRECISION NUMBERS. Briefly, the new technique involves building a table of residues for powers of the base with respect to N; multiplying each digit of the number having a base power larger than N by a corresponding entry in the table; and adding the resulting products together with the portion of the number having the same size as N.

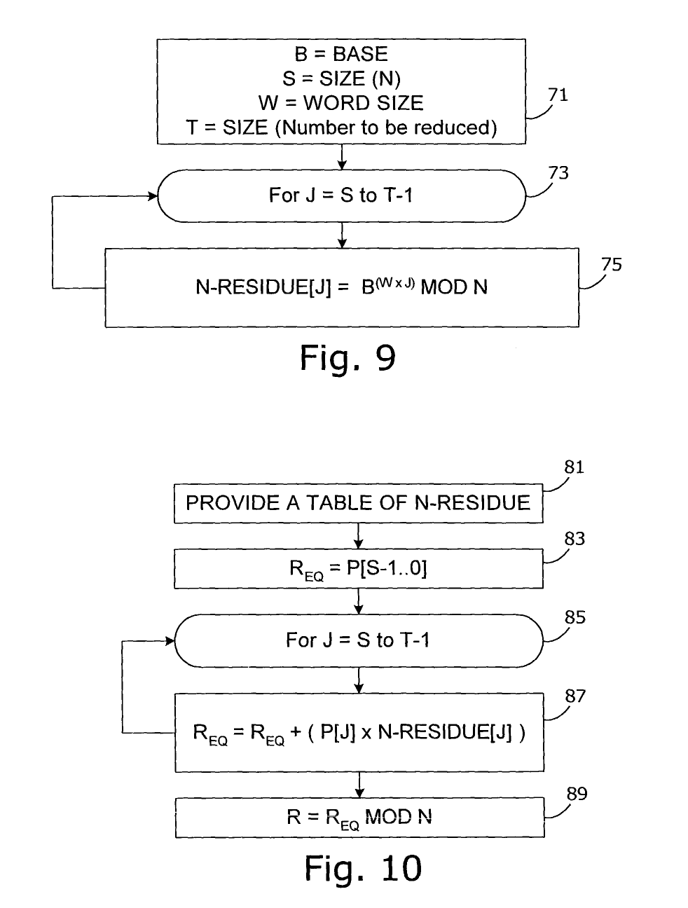

With reference to FIG. 9, a flow diagram shows one example of how to build a table N-Residue for a given base B, residue size S, word size W, and a number size T of the number to be reduced (71). An index variable J loops through values from S to T−1 (73). Each indexed table entry N-Residue[J] is calculated by performing a modular reduction with respect to N for each corresponding power of the base B^{(W×J)}:

N-Residue[J]=B^{(W×J)} MOD N

For a modulus size of S=4, example table entries are as follows:

| Table | For B = 10 | For B = 2 |
|---|---|---|
| Index (J) | and W = 1 | and W = 32 |
| 4 | 10⁴ MOD N | 2¹²⁸ MOD N |
| 5 | 10⁵ MOD N | 2¹⁶⁰ MOD N |
| . | . | . |
| . | . | . |
| . | . | . |
| T − 1 | 10^{T-1} MOD N | 2^{32×(T-1)} MOD N |

For P=41216000 and N=9221, and S=4 (the number of digits in N) and T=8 (the number of digits in P), an example table is as follows:

| J | N-Residue[J] |
|---|---|
| 4 | 10⁴ MOD 9221 = 779 |
| 5 | 10⁵ MOD 9221 = 7790 |
| 6 | 10⁶ MOD 9221 = 4132 |
| 7 | 10⁷ MOD 9221 = 4436 |

With reference to FIG. 10, a table of residues N-Residue is built or provided (81). A variable R_{EQ} is initialized to the first S−1 digits in P (83). A index variable J loops from S to T−1 (85). Each digit P[J] in P (P[S], P[S+1], etc.) is multiplied by a corresponding entry N-Residue[J] in the residue table and the results are added to the variable R_{EQ} (87). The sum of all of the multiplications corresponds to the intermediate value R_{EQ} which is the modular equivalent of the number P. Advantageously, the intermediate result R_{EQ} is a smaller number than the original number P and a simpler modular reduction may be performed (89) to provide the final result R.

For P=41216000 and N=9221, an example reduction is as follows:

| Digit | Operation Performed | REQ |
|---|---|---|
| | R_{EQ}initialized to P[0 . . . 3] | R_{EQ} = 6000 |
| P[4] = 1 | P[4] × N-Residue[4] => | R_{EQ} = 6000 + (1 × 779) = 6779 |
| | 1 × 779 = 779 | |
| P[5] = 2 | P[5] × N-Residue[5] => | R_{EQ} = 6779 + 15580 = 22359 |
| | 2 × 7790 = 15580 | |
| P[6] = 1 | P[6] × N-Residue[6] => | R_{EQ} = 22359 + 4132 = 26491 |
| | 1 × 4132 = 4132 | |
| P[7] = 4 | P[7] × N-Residue[7] => | R_{EQ} = 26491 + 17744 = 44235 |
| | 4 × 4436 = 17744 | |

To check the result: 44235 MOD 9221=7351=41216000 MOD 9221. The technique briefly described above and more fully described in the incorporated application is also well suited to parallel processing as each of the multiplications and additions may be performed independently of each other.

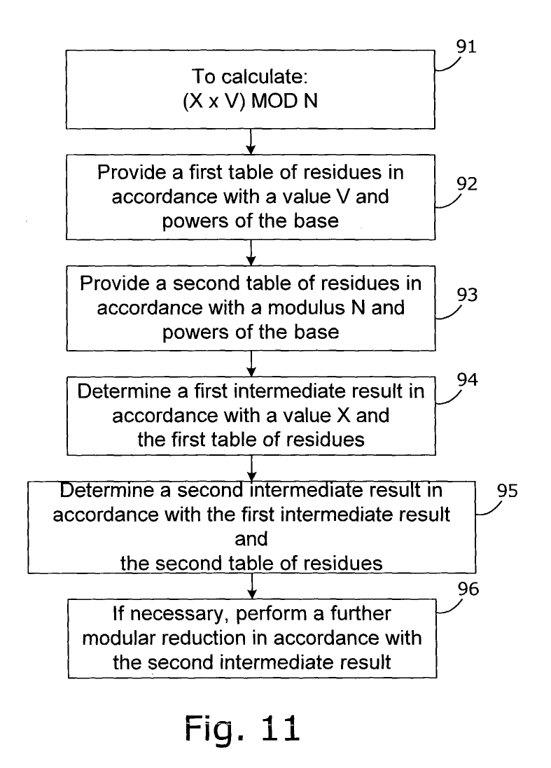

Some examples of the invention utilize a combination of the techniques described above for modular multiplication of multi-precision numbers together with the techniques described above for modular reduction of multi-precision numbers to determine the modular product. With reference to FIG. 11, for a given base B, word size W, values X and V, and a modulus N, the modular product X×V MOD N (91) is determined as follows. A first table of residues (e.g. V-Residue) is provided for the modular product of V and powers of the base with respect to N (92). A second table of residues (e.g. N-Residue) is provided for the modular reduction of powers of the base with respect to N (93). A first intermediate result is determined in accordance with the value X and the first table (94). A second intermediate result is determined in accordance with the first intermediate result and the second table (95). A final modular reduction is performed in accordance with the second intermediate result (96).

For X=8897, V=5152 and N=9221, an example modular product and reduction is as follows:

| Digit | Operation Performed | REQ |
|---|---|---|
| | R_{EQ} initialized to zero | R_{EQ} = 0 |
| X[0] = 7 | X[0] × V-Residue[0] => | R_{EQ} = 0 + 36064 = 36064 |
| | 7 × 5152 = 36064 | |
| X[1] = 9 | X[1] × V-Residue[1] => | R_{EQ} = 36064 + 48735 = 84799 |
| | 9 × 5415 = 48735 | |
| X[2] = 8 | X[2] × V-Residue[2] => | R_{EQ} = 84799 + 64360 = 149159 |
| | 8 × 8045 = 64360 | |
| X[3] = 8 | X[3] × V-Residue[3] => | R_{EQ} = 149159 + 53456 = 202615 |
| | 8 × 6682 = 53456 | |
| | P = R_{EQ} = 202615 | R_{EQ} = 2615 |
| | R_{EQ} re-initialized to | |
| | P[3 . . . 0] | |
| P[4] = 0 | P[4] × N-Residue[4] => | R_{EQ} = 2615 + 0 = 2615 |
| | 0 × 779 = 0 | |
| P[5] = 2 | P[5] × N-Residue[5] => | R_{EQ} = 2615 + 15580 = 18195 |
| | 2 × 7790 = 15580 | |

To check the result: 18195 MOD 9221=8974=202615 MOD 9221=45837344 MOD 9221.

The various tables of residues may be built each time they are needed for a particular reduction. Alternatively, appropriate respective tables of residues may be provided. For example, the tables may be provided together with the encrypted message. Alternatively, after a table has been built with respect to a particular value V and/or modulus N, it may be stored in association with the value/modulus. For example, the V-Residue table would be stored in association with a particular value V and a particular modulus N while the N-Residue table would be stored in association with a particular modulus N. When operating on a new message, the stored tables may be referenced to determine if an appropriate table is already stored for the modulus associated with the new message. Such table storage may be cumulative such that a comprehensive set of tables is built over time. Alternatively, each stored table may have an associated persistence such that the table associated with a particular modulus is stored for a period of time (e.g. minutes, hours, days, weeks, etc.) after the last usage of the table. If a particular table has not been referenced for the prescribed period of time, it is deleted to save storage space.

As noted above, some examples of the invention provide an intermediate result which generally requires further modular reduction to provide the final result. While the intermediate result is a smaller number than the original number, the result of several additions will generally provide an intermediate result that is still larger than the modulus. For example, if the intermediate result is larger than the modulus N, further reduction is required. As noted above, the final result may be provided by conventional modular reduction techniques. One such technique is known as the Montgomery product and may be utilized to perform the final portion of the reduction. The result of the Montgomery product is always at most one times larger than the modulus. Montgomery's technique is used in various cryptography systems. However, the technique requires the calculation of a quotient digit, which is then used in further computations. This strict dependency lowers the amount of parallelism that may be used in the Montgomery reduction computation. According to some examples of the present invention, the use of Montgomery's technique is restricted to a single final digit, thereby removing most of the dependent iterations and increasing the opportunity for parallel processing.

In order to use the Montgomery technique, the numbers (e.g. X and V) are converted to Montgomery form before any calculation. Then the inverse of the conversion is performed to obtain the final result. The successive values of the computation can be left in Montgomery form throughout the calculation, only doing the inversion at the end. Thus the overhead of the conversion is amortized over the entire calculation.

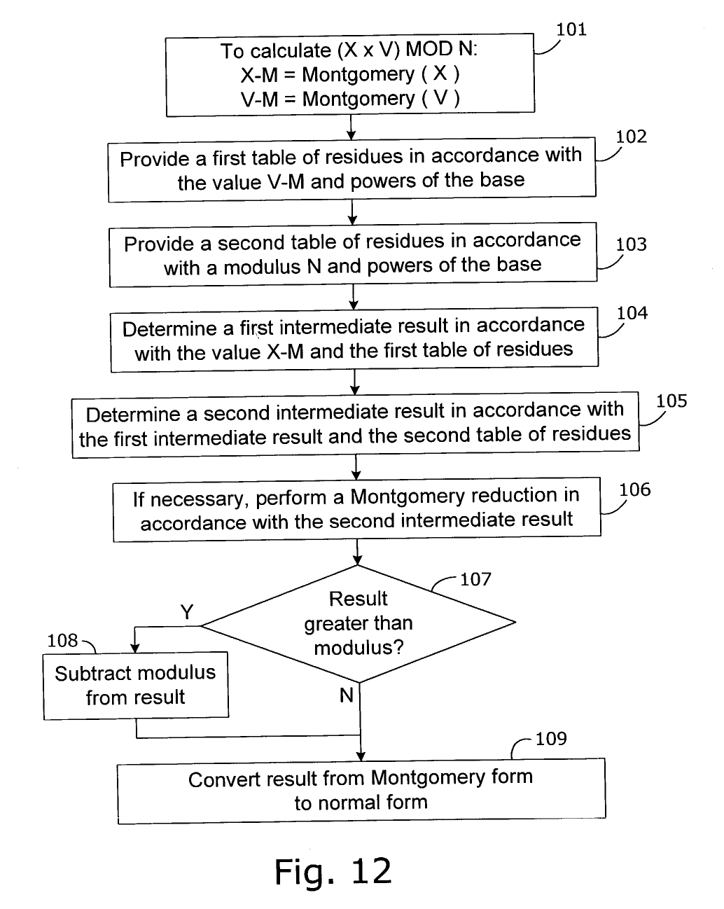

With reference to FIG. 12, for a given base B, word size W, values X and V, and a modulus N (100), the modular product X×V MOD N is determined as follows. X and V are converted to corresponding Montgomery form X−M and V−M (101). A first table of residues (e.g. V-Residue) is provided for the modular product of V−M and powers of the base with respect to N (102). A second table of residues (e.g. N-Residue) is provided for the modular reduction of powers of the base with respect to N (103). A first intermediate result is determined in accordance with the value X−M and the first table (104). A second intermediate result is determined in accordance with the first intermediate result and the second table (105). A Montgomery reduction is performed in accordance with the second intermediate result (106). The result of the Montgomery reduction is compared to the modulus N (107). If the result is greater than the modulus, the modulus is subtracted from the result (108). The result is converted from Montgomery form to normal form (109).

As noted above, one advantage of some examples of the invention is the reduction of serial dependencies and the consequential improvement of performance using parallel processing. According to some other examples of the invention an additional technique for reducing the dependencies in large multiplication and reduction operations is used in combination with the above-described table-driven modular product and modular reduction techniques.

In typical multi-digit addition, it is necessary to perform a carry chain after each operation to avoid overflow conditions on the individual digits of the sum. This effectively makes each part of the addition depend on the previous. But if an additional value (call it the carry) is associate with each digit in the sum, multiple values may be added together, keeping track of the total number of carries, and a single carry operation may be performed after all the additions have been completed. For example, the most significant few bits of a binary word may be designated as carry bits and the lower bits may be designated as the actual sum, thereby allowing the processor to ‘manage’ the carry+sum portion for multiple additions in one binary word. This will allow the processor to add multiple reduced size words together before needing to do the actual carry to avoid overflow.

For example, if a processor has 32-bit words, and the most significant two bits are designated as “carry” bits and the least significant thirty bits are designated as data bits, the processor can add at least four thirty-bit words together before causing overflow. Using our nominal “digit” example from above, a single digit would be thirty bits instead of thirty two. Since the magnitude of each digit is reduced, there may be some overhead in an increased number of additions. But the increased overhead is counter-balanced by the reduced number of carry operations and the reduced dependency between operations. This technique is called ‘delayed carry’ in the rest of this application.

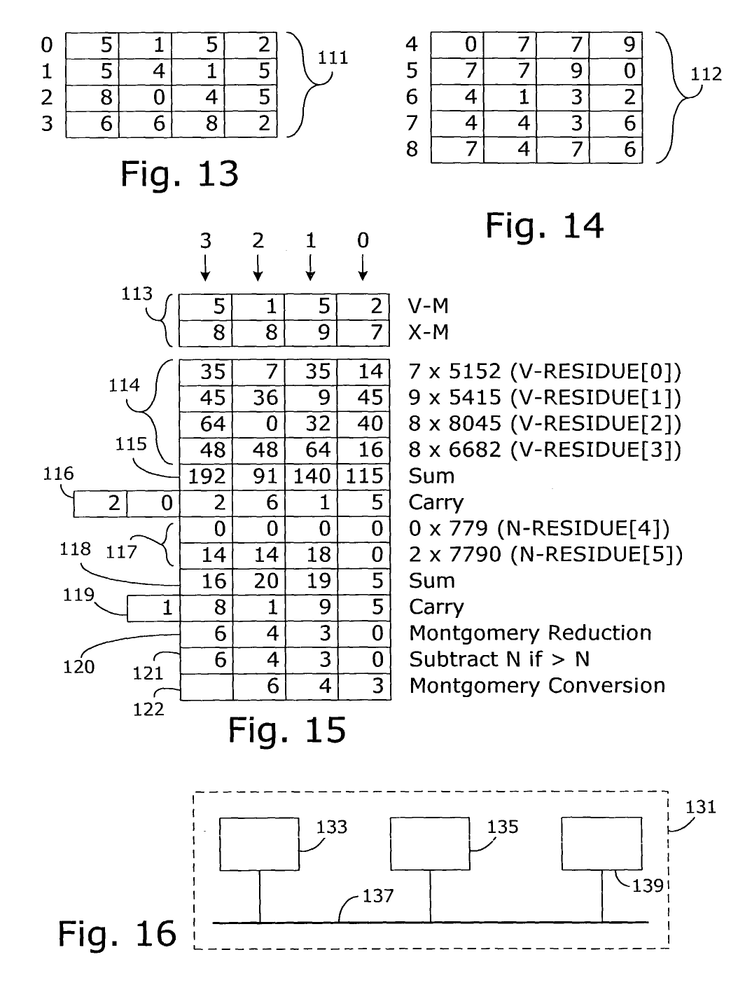

With reference to FIGS. 13-15, some examples of the invention incorporate the table-driven modular product and reduction techniques, together with the Montgomery technique and the delayed carried technique. With reference to FIG. 13, a first table of residues (e.g. V-Residue) is provided for the modular product of V−M and powers of the base with respect to N (111). With reference to FIG. 14, a second table of residues (e.g. N-Residue) is provided for the modular reduction of powers of the base with respect to N (112). For the purpose of this example, the tables are the same as the tables used in the examples above.

With reference to FIG. 15, for X=3656, V=7892, and N=9921, the modular product X×V MOD N is determined as follows. X and V are converted to corresponding Montgomery form X−M=8897 and V−M=5152 (113):

X−M=Montgomery(X)=Montgomery(3656)=8897;

V−M=Montgomery(V)=Montgomery(7892)=5152;

Each digit in X−M is multiplied by the entry in the V-Residue table corresponding to the base power of the digit (114). The resulting products are stored on a delayed carry basis (as described above) for each base power without immediate carry over between columns. For example, the product of 7×5152 results in the entries 7×2=14 in column zero (0); 7×5=35 in column 1; 7×1=7 in column 2; and 7×5=35 in column 3; and so on for the remaining digits in X−M. The resulting products are then added on a column by column delayed carry basis for each base power without immediate carry over between columns (115). For example, the entry in column 1 is the sum of the preceding entries in column 1: 14+45+40+16=115.

The delayed carry is applied to determine the first intermediate result (116). For example, the entry 115 in column 1 results in the 5 in column 1 with 11 carried to column 2; 11+140=151 results in the 1 in column 2 with 15 carried to column 3; 15+91=106 results in the 6 in column 3 with 10 carried to column 4; and 10+192=202 results in the 2 in column 4 with 20 carried in the next two columns. From the earlier examples, it is shown that 202615 MOD 9221 is the modular equivalent of (5152×8897) MOD 9221.

Each digit in the first intermediate result above the size of N (S) is multiplied by the entry in the N-Residue table corresponding to the base power of the digit (117). The resulting products are stored on a delayed carry basis for each base power. The resulting products are then added to digits zero through S−1 of the first intermediate result on a column by column delayed carry basis (118). The delayed carry is applied to determine the second intermediate result (119). From the earlier examples, it is shown that 18195 MOD 9221 is the modular equivalent of 202615 MOD 9221. A Montgomery reduction is performed on the second intermediate result (120). The result of the Montgomery reduction is less than the modulus N, so no further subtraction of N is necessary (121). The result is converted from Montgomery form to normal form (122), with the result of 643. To check our result: 3656×7892 MOD 9221=28853152 MOD 9221; 28853152/9221=3129.0697; 3129*9221=28852509; 28853152−28852509=643.

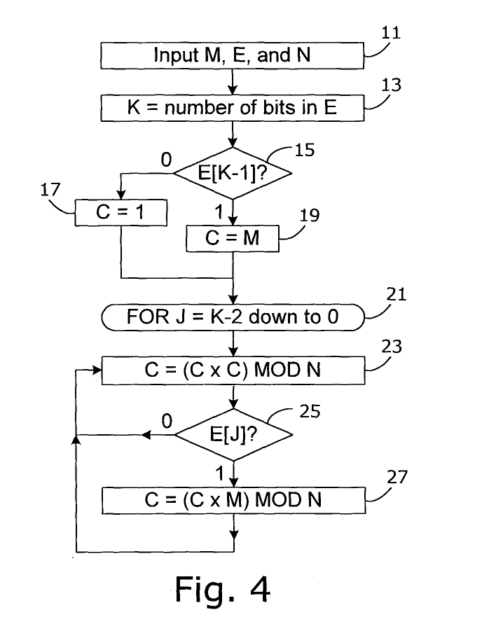

A computer-implemented version of the RSA algorithm utilizing each of the foregoing techniques had the following general attributes. A 29 bit digit size on a 32-bit word size (for delayed carry); use of the new modular reduction technique for the square and reduce operation (e.g. block 23 in FIG. 4); use of the new modular product technique for the extra multiply and reduce operation (if the bit is 1, e.g. block 27 in FIG. 4). Use of Montgomery's technique where needed for a final reduction. Multiplication of two 29 bit numbers results in at most a 58 bit numbers. On a processor that supports 64 bit addition, the six extra bits allow for at least 64 additions without overflow. For a single modular product, it is estimated that the new modular reduction technique provides a 10 percent improvement over conventional techniques and the new modular product technique provides a 40 percent improvement over conventional techniques. In combination for performing binary method type reductions (e.g. the RSA algorithm), it is estimated that some examples of the present invention are 1.25 times faster than conventional techniques, depending on the particular values involved. In one test involving 10,000 iterations, code written with the new techniques was 19% faster than code using conventional techniques.

With reference to FIG. 16, some examples of the invention may be implemented on an electronic system having suitable hardware and software for performing the techniques described herein. For example, an electronic system 131 may include a processor 133; a storage device 135 connected to the processor (e.g. via a bus 137); and a communication device 139 adapted to exchange a message with another electronic system, the communication device 139 being operatively coupled to the storage device 135 and processor 133 (e.g. via the bus 137), wherein the storage device 135 is adapted to store a modulus in association with the message and also to store a table of residues in accordance with a first value of a modular product and powers of a base with respect to the modulus; and the processor 133 is adapted to perform at least one of encrypting the message and decrypting the message using the table of residues. For example, the modular product is associated with the message and the processor 133 is adapted to determine the modular product using the table of residues. In some examples, the processor 133 is adapted to multiply each digit of a second value of the modular product by a corresponding entry in the table; and add the product of each multiplication together to provide a modular equivalent to the modular product. In some examples, the processor 133 is adapted to build the table by multiplying the first value by powers of the base; performing a modular reduction of the product of the multiplication with respect to the modulus; and storing the remainder of the modular reduction in the storage device 135 as an entry in the table in association with respective powers of the base. In some examples, the processor 133 is further adapted to perform a modular reduction on the modular equivalent. For example, where the table of residues comprises a first table of residues, the modular equivalent comprises a first modular equivalent, in some examples the processor 133 is adapted to perform the modular reduction by accessing a second table of residues having entries in accordance with a modular reduction of powers of the base with respect to the modulus; multiplying each digit of the first modular equivalent having a base power larger than the modulus by a corresponding entry in the second table; and adding a portion of the first modular equivalent having base powers less than or equal to the modulus together with the product of each multiplication to provide a second modular equivalent to the modular product. In some examples, the processor 133 is further adapted to perform a modular reduction of the second modular equivalent. In some examples, the processor 133 is adapted to add using a delayed carry.

Some examples of the invention include software which when installed on electronic system enable that system to perform the techniques described herein. For example, the invention may be embodied on a storage media including data and instructions which when executed on an electronic system perform the following process: store a table of residues in accordance with a first value of a modular product and powers of a base with respect to a modulus; multiply each digit of a second value of the modular product by a corresponding entry in the table; and add the product of each multiplication together to provide a modular equivalent to the modular product. In some examples, the storage media includes data and instructions to determine each entry of the table by multiplying the first value by a power of the base; performing a modular reduction of the product of the multiplication with respect to the modulus; and storing the remainder of the modular reduction in the table in association with the power of the base. In some examples, the storage media further comprises data and instructions to perform a modular reduction on the modular equivalent. For example, where the table of residues comprises a first table of residues, the modular equivalent comprises a first modular equivalent, in some examples the storage media further comprises data and instructions to: store a second table of residues in accordance with a modular reduction of powers of the base with respect to the modulus; multiply each digit of the first modular equivalent having a base power larger than the modulus by a corresponding entry in the second table; and add a portion of the first modular equivalent having base powers less than or equal to the modulus together with the product of each multiplication to provide a second modular equivalent to the modular product. The storage media may further comprise data and instructions to perform a modular reduction on the second modular equivalent. In some examples, the storage media further comprises data and instructions to perform the add using a delayed carry.

The foregoing and other aspects of the invention are achieved individually and in combination. The invention should not be construed as requiring two or more of the such aspects unless expressly required by a particular claim. Moreover, while the invention has been described in connection with what is presently considered to be the preferred examples, it is to be understood that the invention is not limited to the disclosed examples, but on the contrary, is intended to cover various modifications and equivalent arrangements included within the spirit and the scope of the invention.

What is claimed is:

1. A method, comprising:
providing a table of residues in accordance with a first value of a modular product and powers of a base with respect to a modulus;
multiplying each digit of a second value of the modular product by a corresponding entry in the table; and
adding the product of each multiplication together to provide a modular equivalent to the modular product.

2. The method as recited in claim 1, wherein providing the table comprises building the table by multiplying the first value by powers of the base; performing a modular reduction of the product of the multiplication with respect to the modulus; and storing the remainder of the modular reduction in the table.

3. The method as recited in claim 1, further comprising:
performing a modular reduction on the modular equivalent.

4. The method as recited in claim 3, wherein the table of residues comprises a first table of residues, the modular equivalent comprises a first modular equivalent, and wherein performing the modular reduction comprises:
providing a second table of residues in accordance with a modular reduction of powers of the base with respect to the modulus;
multiplying each digit of the first modular equivalent having a base power larger than the modulus by a corresponding entry in the second table; and
adding a portion of the first modular equivalent having base powers less than or equal to the modulus together with the product of each multiplication to provide a second modular equivalent to the modular product.

5. The method as recited in claim 4, further comprising:
performing a modular reduction of the second modular equivalent.

6. The method as recited in claim 1, wherein the adding is performed using a delayed carry.

7. A method of performing at least one of encrypting a message and decrypting a message, comprising:
providing a modulus in association with a message;
providing a table of residues in accordance with a first value of a modular product and powers of a base with respect to the modulus;
performing at least one of encrypting the message and decrypting the message using the table of residues.

8. The method as recited in claim 7, wherein the modular product is associated with the message and the performing includes determining the modular product using the table of residues.

9. The method as recited in claim 8, wherein the determining the modular product comprises:
multiplying each digit of a second value of the modular product by a corresponding entry in the table; and
adding the product of each multiplication together to provide a modular equivalent to the modular product.

10. The method as recited in claim 9, wherein providing the table comprises building the table by multiplying the first value by powers of the base; performing a modular reduction of the product of the multiplication with respect to the modulus; and storing the remainder of the modular reduction in the table.

11. The method as recited in claim 9, further comprising:
performing a modular reduction on the modular equivalent.

12. The method as recited in claim 11, wherein the table of residues comprises a first table of residues, the modular equivalent comprises a first modular equivalent, and wherein performing the modular reduction comprises:
providing a second table of residues in accordance with a modular reduction of powers of the base with respect to the modulus;
multiplying each digit of the first modular equivalent having a base power larger than the modulus by a corresponding entry in the second table; and
adding a portion of the first modular equivalent having base powers less than or equal to the modulus together with the product of each multiplication to provide a second modular equivalent to the modular product.

13. The method as recited in claim 12, further comprising:
performing a modular reduction of the second modular equivalent.

14. The method as recited in claim 9, wherein the adding is performed using a delayed carry.

15. An electronic system, comprising:
a processor;
a storage device connected to the processor; and
a communication device adapted to exchange a message with another electronic system, the communication device being operatively coupled to the storage device and processor, wherein
the storage device is adapted to store a modulus in association with the message and also to store a table of residues in accordance with a first value of a modular product and powers of a base with respect to the modulus; and
the processor is adapted to perform at least one of encrypting the message and decrypting the message using the table of residues.

16. The system as recited in claim 15, wherein the modular product is associated with the message and the processor is adapted to determine the modular product using the table of residues.

17. The system as recited in claim 16, wherein the processor is adapted to:
multiply each digit of a second value of the modular product by a corresponding entry in the table; and
add the product of each multiplication together to provide a modular equivalent to the modular product.

18. The system as recited in claim 17, wherein the processor is adapted to build the table by multiplying the first value by powers of the base; performing a modular reduction of the product of the multiplication with respect to the modulus; and storing the remainder of the modular reduction in the storage device as an entry in the table in association with respective powers of the base.

19. The system as recited in claim 17, wherein the processor is further adapted to perform a modular reduction on the modular equivalent.

20. The system as recited in claim 19, wherein the table of residues comprises a first table of residues, the modular equivalent comprises a first modular equivalent, and wherein the processor is adapted to perform the modular reduction by accessing a second table of residues having entries in accordance with a modular reduction of powers of the base with respect to the modulus; multiplying each digit of the first modular equivalent having a base power larger than the modulus by a corresponding entry in the second table; and adding a portion of the first modular equivalent having base powers less than or equal to the modulus together with the product of each multiplication to provide a second modular equivalent to the modular product.

21. The system as recited in claim 20, wherein the processor is further adapted to perform a modular reduction of the second modular equivalent.

22. The system as recited in claim 17, wherein the processor is adapted to add using a delayed carry.

23. A storage media including data and instructions which when executed on an electronic system perform the following process:
store a table of residues in accordance with a first value of a modular product and powers of a base with respect to a modulus;
multiply each digit of a second value of the modular product by a corresponding entry in the table; and
add the product of each multiplication together to provide a modular equivalent to the modular product.

24. The media as recited in claim 23, wherein the storage media includes data and instructions to determine each entry of the table by multiplying the first value by a power of the base; performing a modular reduction of the product of the multiplication with respect to the modulus; and storing the remainder of the modular reduction in the table in association with the power of the base.

25. The media as recited in claim 23, further comprising data and instructions to perform a modular reduction on the modular equivalent.

26. The media as recited in claim 25, wherein the table of residues comprises a first table of residues, the modular equivalent comprises a first modular equivalent, and wherein the media further comprises data and instructions to:
store a second table of residues in accordance with a modular reduction of powers of the base with respect to the modulus;
multiply each digit of the first modular equivalent having a base power larger than the modulus by a corresponding entry in the second table; and
add a portion of the first modular equivalent having base powers less than or equal to the modulus together with the product of each multiplication to provide a second modular equivalent to the modular product.

27. The media as recited in claim 26, further comprising data and instructions to perform a modular reduction on the second modular equivalent.

28. The media as recited in claim 23, further comprising data and instructions to perform the add using a delayed carry.
